(19) United States
(12) Patent Application Publication
(10) Pub. No.: US 2007/0111170 A1
(43) Pub. Date: May 17, 2007

(54) Vehicle simulator

(76) Inventor: Norman Lefton, Los Angeles, CA (US)

Correspondence Address: CHRISTIE, PARKER & HALE, LLP, PO BOX 7068, PASADENA, CA, 91109-7068, US

(21) Appl. No.: 11/599,866

(22) Filed: Nov. 14, 2006

Related U.S. Application Data
(60) Provisional application No. 60/736,743, filed on Nov. 14, 2005.

(51) Int. Cl. G09B 9/02; G09B 19/16

(52) U.S. Cl. 434/29

(57) ABSTRACT

The invention is a vehicle simulator. It includes a vehicle simulator operator environment, a vehicle simulator base, a boom connecting the vehicle simulator operator environment to the vehicle simulator base, a plurality of articulations for rotating the vehicle simulator operator environment along at least one axis of rotational motion, and a plurality of articulations for moving the vehicle simulator operator environment along at least one axis of translational motion with the boom relative to the vehicle simulator base.

### CROSS-REFERENCE TO RELATED APPLICATION(S)

This application claims the benefit of U.S. Provisional Patent Application No. 60/736,743, entitled “Vehicle Simulator”, filed on Nov. 14, 2005.

### SUMMARY OF THE INVENTION

Vehicle Motion Simulators have been available for many decades and are used for a variety of purposes including for training of operators of military and commercial motor vehicles, heavy machinery and aircraft. For example, there are variety of flight simulators for helicopters, jets and propeller aircraft, as well as driver training simulators for trucks, boats, tanks and trains, gunnery training simulators for tanks, wheeled vehicles and boats, mission training simulators for rescue crew and drivers, and industrial simulators and material handling equipment training simulators. In addition to these uses, simulators are used in the entertainment field for a variety of amusement park rides, in museums, in video arcades, etc.

Regardless of their applications, most simulators rely on a motion base to create the various motions that are responsive to operator input or some pre-programmed input, which simulators translate these inputs into various motions, including tilting, shaking, thrusting, etc. A common type of motion base includes a floor mounted base unit, a floating platform, and a number of hydraulic or electric cylinders connecting the base of the floating platform. By adjusting the motions of the plurality of cylinders, different degrees of motion can be achieved. For example, Moog Inc. of East Aurora, N.Y., manufactures a variety of motion bases which utilize six hydraulic or electric cylinders arranged in a multiple V-formation. Due to the complicated nature of the various motions required by the cylinders to achieve a desired effect, a considerable degree of programming with tight tolerances is required for effective operation. Moreover, these types of motion bases are very heavy, and must be mounted to a very secure foundation, such as a six-foot thick reinforced concrete base due to the shaking forces created by the motion base. The simulator environment (such as with a simulated cockpit of an aircraft, a lunar lander, a spacecraft, or other types of vehicles) will be located on top of the motion base. Typically, it is difficult to swap between the use of a simulator for one purpose (e.g., helicopter simulator) with another purpose (e.g., tank simulator), since it requires a substantial amount of reprogramming and customization. For this reason, vehicle simulators are usually set up to represent one type of vehicle.

Moreover, most simulators operate either in a limited number of degrees of freedom of motion, i.e., translational motion in the x, y and/or z planes, and rotational motion along x, y or z axes, and/or their range of translational motions or rotational motions are limited.

There accordingly remains a need for lower cost simulators that are easier and less expensive to use and operate and also more versatile for a variety of applications, and also for simulators that have greater number and degrees of freedom of motion.

### BRIEF DESCRIPTION

The invention comprises a vehicle simulator and vehicle operator environment which provides for up to six degrees of freedom of motion, which simulator may be portable.

The vehicle simulator and vehicle operator environment may optionally provide for adaptability to various simulator environments, e.g., helicopters, tanks, fixed wing aircraft, trucks, motorcycles, spacecraft, etc., without requiring complex reprogramming or replacement of the entire operator environment. The vehicle simulator provides for up to six degrees of freedom of motion, which comprise rotational motion of the operator environment around the x, y and z axis, plus translational motion of the vehicle operator environment in lateral x, lateral y, and lateral z directions, to provide for full range of motions including full spins, rolls, and other motions which are not possible with present day vehicle simulators based on a motion base consisting of a plurality of cylinders connected between the base and a floating platform.

The vehicle simulator of the invention can move in the six degrees of freedom based on a relatively simple design that uses groups of actuating cylinders, motors, or other motion control devices to move the operator environment along the desired axes of rotation and longitudinal motion, and can thus obviate the need for complex mechanical structure or difficult to program software and firmware.

### BRIEF DESCRIPTION OF THE DRAWINGS

FIG. 1 is a diagrammatic perspective view of a prior art motion base for a vehicle simulator.

FIG. 2 is a side view of an exemplary vehicle simulator of the invention.

FIG. 3 is a top view of the exemplary vehicle simulator of FIG. 2.

FIG. 4 is a diagrammatic front right isometric view showing the exemplary simulator of FIG. 2 showing its six degrees of freedom of motion.

FIG. 5 is a front right isometric view of another exemplary vehicle simulator operator environment.

FIG. 6 is a diagrammatic isometric view of an embodiment of a vehicle operator environment with swappable controls.

### DETAILED DESCRIPTION OF THE INVENTION

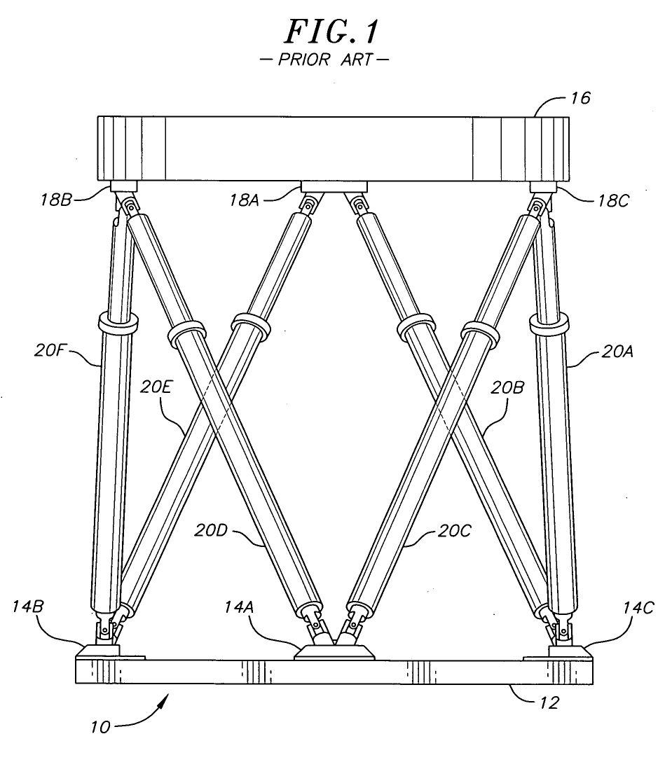

Referring to FIG. 1, there is shown a prior art motion base 10, which has a base portion 12 with three lower anchors, 14A, 14B and 14C, a floating platform portion 16 with upper anchors 18A, 18B and 18C. Six hydraulic or electric cylinders 20A through 20F connected between the lower anchors 14A, 14B and 14C to the upper anchors 18A, 18B and 18C of the floating platform 16. Cylinder 20A connects at its bottom via a universal joint to anchor 14C and at its top to the anchor 18C, also with a universal joint or other pivot. Cylinder 20B connects at its bottom portion to anchor 14C and at its top to anchor 18A by a universal joint or other pivot. The other cylinders are similarly connected. Cylinder 20C connects at its bottom portion to anchor 14A and at its top to anchor 18C. Cylinder 20D connects at its bottom portion to anchor 14A and to its top to anchor 18B. Cylinder 20E connects at its bottom portion to anchor 14B and connects to anchor 18A at its top. Lastly, cylinder 20F connects at its bottom to corner 14B and at anchor position 18B at its top. Thus, by manipulating the position, thrusts, speeds, etc. of cylinders 20A through 20F, the floating platform 16 can be moved as desired. Not shown, a cockpit or cabin will be mounted to the floating platform 16 where an operator, passengers, etc., will be situated during motion. Motion of the floating base 16 relative to the stationary base 12 requires extremely precise movement of all the cylinders relative to each other, otherwise, the cylinders will actually work against each other and can cause premature wear and breakage. Of course, while the prior art motion bases can establish six degrees of freedom of motion to a limited degree, but these designs restrict the extent of the motions, e.g. full rolls and spins cannot be fully replicated.

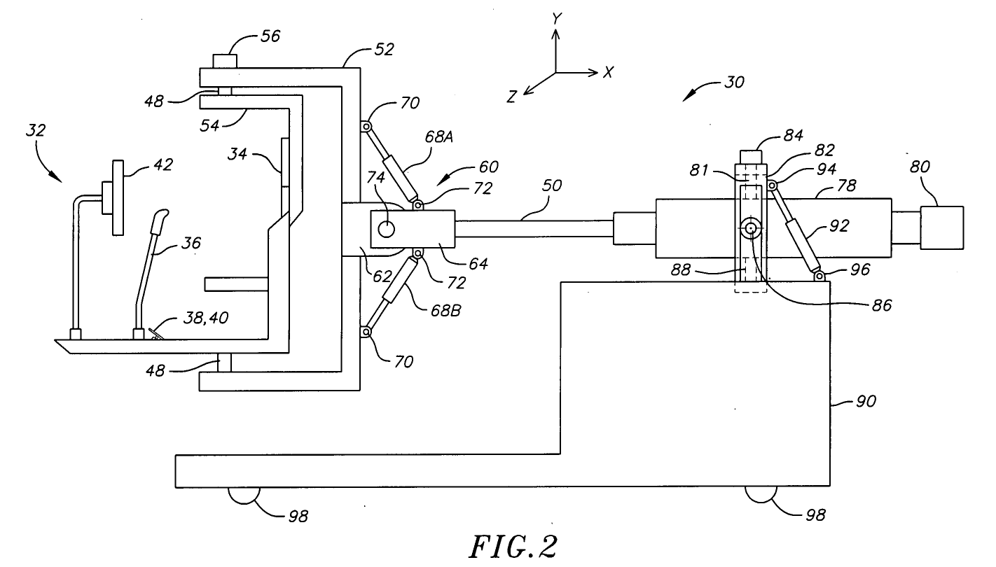

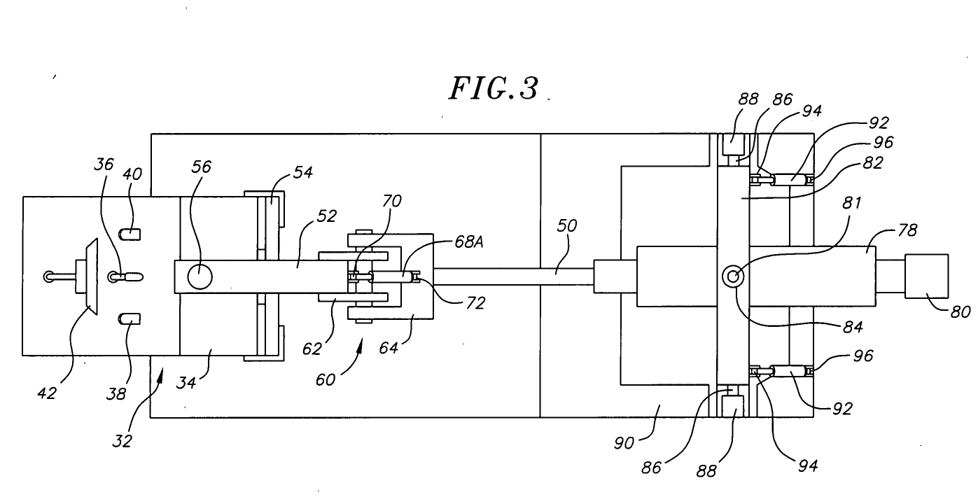

Turning now to FIGS. 2 and 3, there are shown a right side view and a top view of an exemplary embodiment of a vehicle simulator 30 of the invention. The vehicle simulator 30 includes an operator environment 32 which includes a seat 34 with various operator controls, such as a joystick 36, foot peddles 38 and 40 and a control panel 42. As will be explained below, other operator environments can be provided. The operator environment 32 is connected to a boom 50 via an operator environment carriage 52. The operator environment 32 includes a cabin frame 54 which is attached to the operator environment carriage 52 via a pivot 48. The cabin frame 54 and the operator environment 32 can be rotated relative to the operator environment carriage 52 via a yaw adjustor 56, which can for example comprise a rotation drive motion actuating device and mechanism, such as motor. This will effect movement of the operator environment on a “Y” axis. The operator environment carriage 52 can be pivotally moved relative to the axis of the boom 50 by incorporating, for example, a clevis joint 60 between the operator environment carriage 52 and the boom 50. For example, a tang 62 can extend from the operator environment carriage 52 and a clevis 64 can be attached to the boom 50. In order to affect incline control of the operator environment and the operator environment carriage 52 relative to the boom 50, a pivot drive motion actuating device and mechanism, such as one or more incline controllers 68A, 68B may span between the clevis 64 and the operator environment carriage 52. For example, the incline controllers 68A and 68B can comprise a cylinder (such a pneumatic hydraulic or electric cylinder) which is pivotally connected at one end 70 to the operator environment carriage and at its other end 72 to the clevis 64. The tang 62 is connected to the clevis by a pivot 74. Other known mechanisms can be used instead if desired. The pivot 48 between the cabin frame 54 and the operator environment carriage 52, along with its yaw adjuster (e.g., a motor 56) will affect a rotational movement along the pivot 48 which is generally along a Y axis when in an upright position. Again, the movement of the operator environment 32 relative to the incline adjuster established by the clevis joint 60 will affect movement of the operator environment along an axis of rotation of the Z axis which passes through the pivot 74 of the clevis joint 60. The operator environment 32 will also be rotatable along the X axis which runs through a longitudinal axis of the boom 50. The boom 50 passes through a boom housing 78 and is turned relative thereto by a spin drive motion actuating device and mechanism, for example, a motor 80, which rotates the boom 50 relative to the boom housing 78. Alternately, the operator environment 32 can rotate on its X axis relative to an unrotating boom 50 (e.g. by a motor placed between the boom and the operator environment 32.) Thus, the operator environment 32 can rotate on its X axis (via the pivots 48, along the Z axis along a clevis pivot 74), and along the X axis rotation of the boom 50 relative to the housing 78. The translational motions of the operating environment can also be established by the vehicle simulator 30. The boom 50 will longitudinally move through the boom housing 78 along the X axis by virtue of an X-axis drive motion actuating device and mechanism, such as a motor, a hydraulic or pneumatic cylinder, or another mechanisms (not shown) which shifts the boom 50 to the left or right through the boom housing 78. The boom housing 78 is in turn connected along a Y axis through a vertical housing pivot 81, which connects the boom housing 78 to a housing frame 82. Rotation along the vertical housing pivot 81 can be effectuated by a Z-axis drive motion actuating device and mechanism, such as a motor 84 or another mechanism. Thus, the operator environment 32 can be shifted from side to side relative to the Z axis. The housing frame 82 in turn is pivotably mounted on a horizontal pivot 86, which connects to housing frame support 88, which is carried by a simulator base 90. In order to effect movement of the housing frame 82 and its carried housing frame 78, boom 50 and operator environment 32 up and down, a Y-axis drive motion actuating device and mechanism to establish tilting up and down of the boom is provided. It can conveniently comprise, for example, hydraulic, pneumatic or electromechanical cylinders 92 connected between the simulator base 90 and the housing frame 82. However, other devices and mechanism can be used. The drive mechanism 92 is connected at an upper end to a pivot 94 connected to the housing frame 82 and at a bottom end 96 to the simulator base 90. The simulator base can optionally incorporate wheels 98 to permit the simulator to be moved. These wheels 98 can be locked in place or retracted into the simulator base 90 to lower the base onto complete contact with the floor surface.

By operating the tilt mechanism, the housing frame 82 and its carried housing 78, boom 50 and operator environment 32 can be swung up and down on the Z axis passing through the horizontal pivot 86. Thus, by virtue of these articulations, translational movement of the operator environment 32 can be made along the X axis when the boom 50 telescopically moves relative to the boom housing 78; translational movement relative to the Z axis can be made by swinging the boom housing 78 along the vertical housing pivot 81; and translational movements along the Y axis can be made by pivoting the boom housing 78 along the horizontal pivot 86. Accordingly, the vehicle simulator 30 of the invention provides for six degrees of freedom, namely, three degrees of rotational freedom and three degrees of translational freedom. Moreover, unlike the prior art motion bases, much fuller motions can be achieved, such as full rolling motions and spinning motions. Furthermore, depending on the degree of incline of the operator environment 32 relative to the boom 50, much sharper inclines can be achieved than are possible with traditional motion bases. Also, these greater degrees of motion can be had with greater mechanical simplicity and much simpler software design since the geometry of the inventive design is much simpler as calculations of movement are made around single axis of movement, whereas with prior motion basis, there is a complex relationship of the plurality of cylinder, i.e., six cylinders that must work in coordination in order to move the floating platform relative to a stationary base.

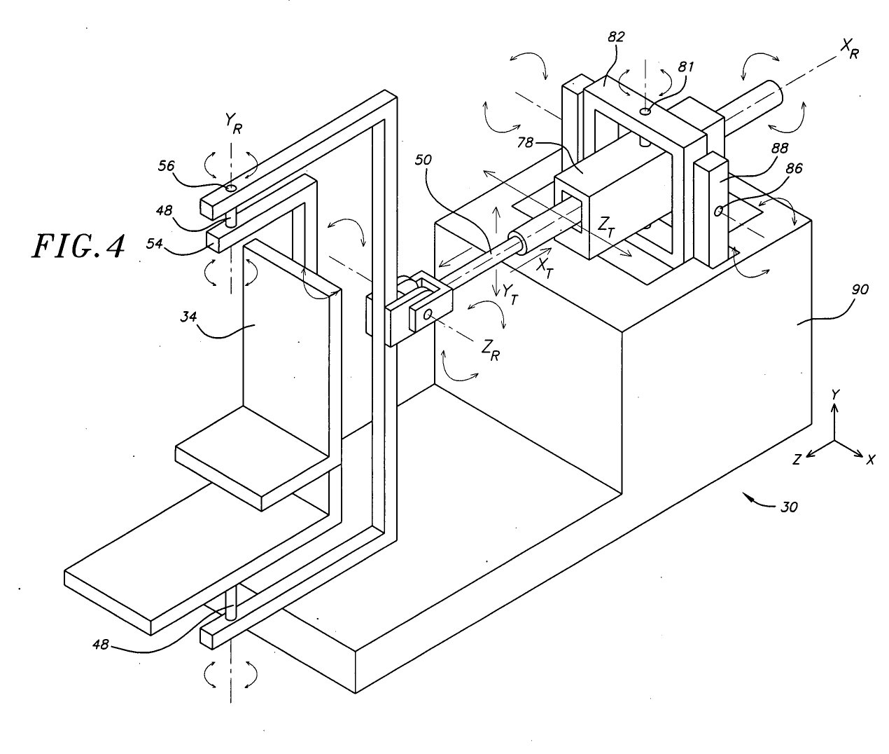

Turning now to FIG. 4, there is shown a diagrammatic, top right isometric view of the exemplary vehicle simulator 30 of FIGS. 2 and 3, not showing the various motors and cylinders to effect motion. The axis of rotational motion are indicated as X_{R}, Y_{R} and Z_{R}. The translational axis of motion are shown by arrows X_{T}, Y_{T} and Z_{T}. The seat 34, boom 50, cabin frame 54 which is attached to the operator environment carriage 52 via the pivot 48. The boom housing 78, the vertical housing pivot 81, which connects the boom housing 78 to a housing frame 82 are shown. The housing frame 82 pivotable on the horizontal pivot 86, which connects to housing frame support 88, which in turn are carried by the simulator base 90 are also shown.

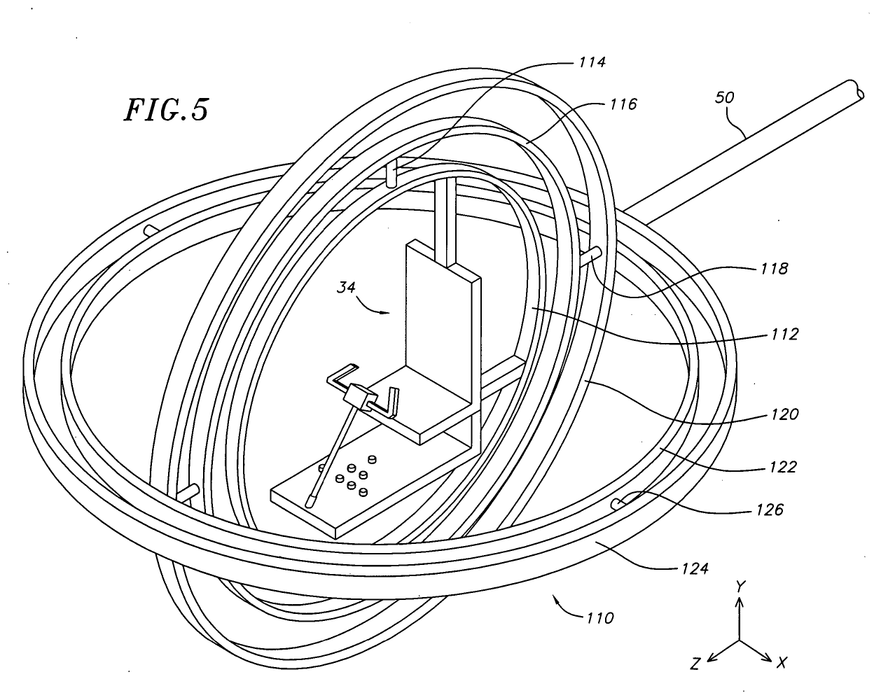

FIG. 5 is a diagrammatic isometric use showing another exemplary operator environment 110 which provides for 360 degrees of rotational motion about each of its x axis, y axis and z axis. This is accomplished by providing the plurality of concentrically connected frames which connect each frame relative to a next frame so that each frame will perpendicularly rotate relative to its next frame. The frames will rotate about the x, y and z axis. They can be connected to the boom 50 in the same manner as the operator environment 32 shown in FIGS. 2 and 3. An inner frame 112 contains the same componentry as would be present in the user environment of FIGS. 2 and 3 and will not be discussed further. The inner frame 112 is pivotally connected via pivots 114 on a Y axis to an intermediate frame 116. The intermediate frame 116 in turn is connected to an outer frame 120 by X axis pivots 118. The outer frame 120 is affixed to a perpendicular frame 122. The perpendicular frame 122 is connected via pivot 126 to an exterior frame 124. The exterior frame 124 will be connected to a boom 50. If the boom 50 is rotatable, the frame that is provided to permit rotation around the x-axis can be eliminated. The motors to turn the frames relative to each other to establish the rotational motors are not shown. Although the various frames are shown as being generally circular, they may have other shapes if desired.

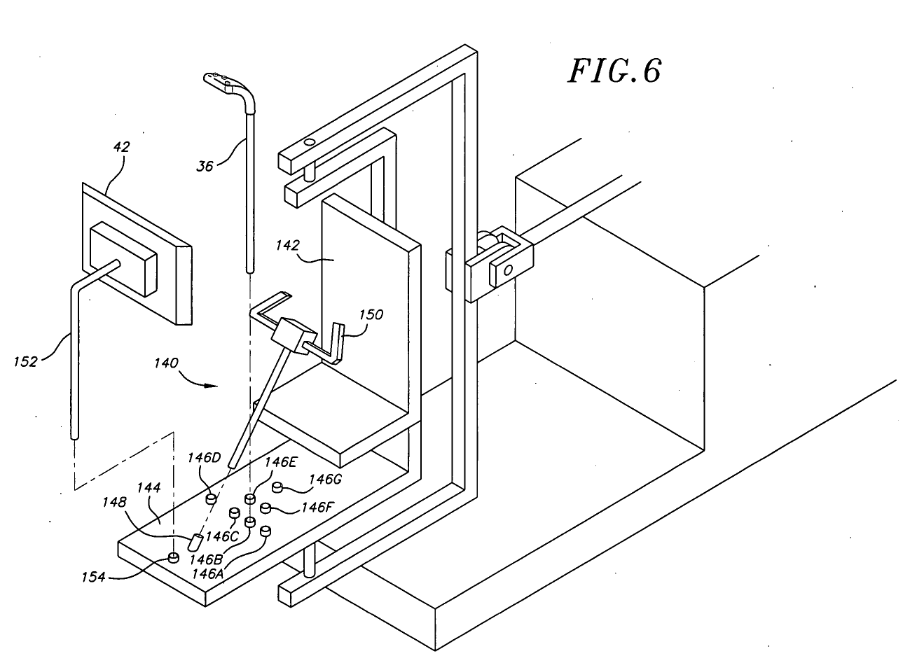

FIG. 6 is a front isometric diagrammatic view of an exemplary operator environment 140. It includes an occupant seat 142 and an occupant floor surface 144. Placed on the floor surface 144 are a plurality of ports 146A through 146G and port 148. These ports are adapted to receive various control inputs such as the pedals 38 and 40 (as shown on FIG. 3), a joy stick 36, an airplane type steering wheel assembly 150 and/or other control inputs which are not shown, and which will depend on the vehicle being simulated. The number, pattern, spacing and type of ports 146a through 146g can be placed in the appropriate locations to receive input devices as required to simulate the desired vehicle operating environment. The individual ports 146A through 146G and/or devices that engage therewith can include electrical and electronic connections, electromechanical motion sensing and driving mechanisms, stress sensors and other drives and sensors which simulate the controls of the vehicle that is being simulated. By way of example, the joystick port 146B may include a motorized module to provide the appropriate resistance that would be experienced by a helicopter pilot when operating the joystick, pending on the operation being performed. For example, when in a simulated helicopter, while recovering from a fast and steep dive, more force will be required compared to moving the joystick than during more subtle changes to the simulated helicopter's direction. The same would apply to the airplane steering wheels control 150 and its port 148. Accordingly, the operating environment 140 can remain in the place, but depending on what vehicle is to be simulated, different control devices can be inserted into the various ports. Optional control panel 42 on a control panel shaft 152 can be placed in a port 154 and by selecting the desired vehicle to be simulated, the control panel can instruct the user which ports to use and what controls to insert in which port, if desired. Other ways to control what type of vehicle is being simulated can be used. For example, the operator environment and its controls and components can be set up to recognize that a certain combination of components engaged with certain ports equates to a certain vehicle, e.g., a tank, a helicopter, a fixed wing airplane, etc. Hardware and software communication will be established between the ports and the controllers, and will be communicated to the various control devices so that appropriate movement of the operator environment is established by the user operating the simulated vehicle. For example, in the case of the joystick, by pushing forward on the joystick, this will communicate via port 146B and cause the operator environment to be inclined downwardly. As noted above, since the operator environment will move on distinct axis of rotation and translation, the programming would be much simpler than with prior art devices.

The system can be programmed to run an operator through various scenarios, such as sudden lose of power, lose of a rotor, rough weather, etc., and the operator will need to respond to same. The system can collect and/or rate the operator's response for training and feedback purposes.

Also, the ability to customize and save various operator environments can be included in the software and firmware that directs the motion control cylinders, motors and control. For example, the operator or others may be able to change setting to more closely reflect how a certain vehicle responds to certain conditions in real life conditions. Different models of helicopters may include the same controls, but may respond differently to flying conditions.

One or more computers can be used to for communications and control between the operator controls in the vehicle operator environment and the motion actuating devices and mechanisms that actually are responsible for the degrees of motion. These computer(s) will translate movement and/or other actuating of the operator controls in the vehicle operator environment to the motion actuating devices and mechanisms that actually are responsible for the six degrees of motion. Moreover, theses computer(s) can be programmed to establish the desired responses.

Although preferred embodiments of the present invention have been described, it should not be construed to limit the scope of the invention. In addition, those skilled in the art will understand that various modifications may be made to the described embodiments. Moreover, to those skilled in the various arts, the invention itself herein will suggest solutions to other tasks and adaptations for other applications. It is therefore desired that the present embodiments be considered in all respects as illustrated and not restrictive.

What is claimed is:

1. A vehicle simulator, comprising:
a vehicle simulator operator environment;
a vehicle simulator base;
a boom connecting the vehicle simulator operator environment to the vehicle simulator base;
a mechanism for rotating the vehicle simulator operator environment along at least one axis of rotational motion relative to the vehicle simulator base; and
a mechanism for translating the vehicle simulator operator environment along at least one axis of translational motion relative to the vehicle simulator base.

2. The vehicle simulator of claim 1, wherein movement of the boom provides the translational motion of the vehicle simulator operator environment relative to the vehicle simulator base.

3. The vehicle simulator of claim 1, wherein the mechanism for rotating the vehicle simulator operator environment along at least one axis of rotational motion relative to the vehicle simulator base comprises a cabin frame that is pivotally connected along a Y axis to an operator environment carriage, which operator environment carriage is connected to the boom, and a rotation drive motion actuating device and mechanism to provide for rotation of the vehicle simulator operator environment along the Y axis.

4. The vehicle simulator of claim 1, wherein the mechanism for rotating the vehicle simulator operator environment along at least one axis of rotational motion relative to the vehicle simulator base comprises an operator environment carriage that is attached directly or indirectly to the vehicle simulator operator environment, and a pivot drive motion actuating device and mechanism, wherein the operator environment carriage is pivotally connected along a Z axis relative to the boom to provide for rotation of the vehicle simulator operator environment along the Z axis relative to the boom to establish a tilting movement of the vehicle simulator operator environment relative to the boom.

5. The vehicle simulator of claim 1, wherein the mechanism for rotating the vehicle simulator operator environment along at least one axis of rotational motion relative to the vehicle simulator base comprises a spin drive motion actuating device and mechanism adapted to either rotate the boom and its connected vehicle simulator operator environment along an X axis relative to the vehicle simulator base or adapted to rotate the vehicle simulator operator environment relative to the boom to establish a spinning movement of the vehicle simulator operator environment along the X axis of the boom relative to the vehicle simulator base.

6. The vehicle simulator of claim 1, wherein the vehicle simulator operator environment is rotatable along a X axis, a Y axis, and a Z axis relative to the vehicle simulator base, comprises a cabin frame that is pivotally connected along a Y axis to an operator environment carriage, which operator environment carriage is connected to the boom, and a rotation drive motion actuating device and mechanism to provide for rotation of the vehicle simulator operator environment along the Y axis, the operator environment carriage being pivotally connected along a Z axis relative to the boom and a pivot drive motion actuating device and mechanism being provided to rotate of the vehicle simulator operator environment along the Z axis relative to the boom to establish a tilting movement of the vehicle simulator operator environment relative to the boom, and a spin drive motion actuating device and mechanism adapted to either rotate the boom and its connected vehicle simulator operator environment along an X axis relative to the vehicle simulator base or adapted to rotate the vehicle simulator operator environment relative to the boom to establish a spinning movement of the vehicle simulator operator environment along the X axis of the boom relative to the vehicle simulator base.

7. The vehicle simulator of claim 1, wherein the boom is moveable for translational movement of the vehicle simulator operator environment at least along one of an X axis, a Y axis, and/or a Z-axis, wherein for translational movement along the X-axis the boom is longitudinally moveable along the X axis relative the vehicle simulator base, wherein for translational movement along the Y-axis the boom is pivotable up and down relative to the vehicle simulator base, and/or wherein for translational movement along the Z axis, the boom is swingable from side to side.

8. The vehicle simulator of claim 7, wherein an X-axis drive motion actuating device and mechanism moves the boom longitudinally moves through a boom housing to provide the longitudinal movement of the vehicle simulator operator environment along the X axis.

9. The vehicle simulator of claim 7, wherein a Y-axis drive motion actuating device and mechanism pivots the boom longitudinally up and down relative to the vehicle simulator base to establish translational movement of the vehicle simulator operator environment along the Y axis.

10. The vehicle simulator of claim 7, wherein a Z-axis drive motion actuating device and mechanism pivots the boom longitudinally side to side relative to the vehicle simulator base to establish translational movement of the vehicle simulator operator environment along the Z axis.

11. The vehicle simulator of claim 1, further comprising a computer to establish communication between the simulator control device and/or display in the vehicle simulator operator environment and motion actuating devices and mechanisms that are responsible for moving the vehicle simulator operator environment relative to the boom and the boom relative to the vehicle simulator base.

12. The vehicle simulator of claim 1, wherein the vehicle simulator operator environment comprises at least one port that is adapted to receive a simulator control device and/or display that corresponds to a vehicle to be simulated.

13. The vehicle simulator of claim 12, wherein the vehicle simulator operator environment comprises a plurality of ports, which plurality of ports are adapted to engage with simulator control devices and/or displays that corresponds to a vehicle to be simulated.

14. The vehicle simulator operator environment of claim 13, wherein the plurality of ports comprises at least one port that includes at least one of electrical connections and mechanical connections that communicate with a simulator control device and/or display that has been engaged therewith, and at least one port that includes a mechanism that provides an appropriate degree of at least one of resistance and movement of a simulator control device engaged therewith.

15. The vehicle simulator operator environment of claim 12, wherein by providing different sets of control devices and/or displays, different vehicles can be simulated.

16. The vehicle simulator operator environment of claim 15, wherein by engaging a predetermined set of control devices and/or displays that correspond to a particular vehicle to be simulated with a predetermined set of ports, the vehicle simulator will be operable as a vehicle simulator for the particular simulated vehicle.

17. The vehicle simulator of claim 12, further comprising a computer to establish communication between the simulator control device and/or display in the vehicle simulator operator environment and motion actuating devices and mechanisms that are responsible for moving the vehicle simulator operator environment relative to the boom and the boom relative to the vehicle simulator base.
